(19) United States
(12) Patent Application Publication
(10) Pub. No.: US 2017/0095910 A1
(43) Pub. Date: Apr. 6, 2017

(54) Easy-to-Convey Heavy Duty Striking Wrench

(71) Applicant: Bobby Hu, Taichung City (TW)

(72) Inventor: Bobby Hu, Taichung City (TW)

(21) Appl. No.: 14/941,813

(22) Filed: Nov. 16, 2015

(30) Foreign Application Priority Data
Oct. 2, 2015 (TW) 104132645

(51) Int. Cl. B25B 19/00; B25B 13/48; B25B 13/08

(52) U.S. Cl. CPC B25B 19/00; B25B 13/08; B25B 13/48

(57) ABSTRACT

An easy-to-convey heavy duty striking wrench includes a main body having a weight more than 20 kg and having a head and a body integrally connected to the head. The head engaged with a fastener can rotate about a working axis coincident with a rotating axis of the fastener. An axis passes through the center of gravity of the main body and is parallel to the working axis of the head. The main body further includes a first conveying device configured to be applied with a force through manual or mechanical operation to overcome the weight of the main body, permitting conveyance of the main body. The main body is rotatable about the axis to adjust an angular position of the main body relative to the fastener.

### BACKGROUND OF THE INVENTION

The present invention relates to a striking wrench and, more particularly, to an easy-to-convey heavy duty striking wrench.

Striking wrenches are one of large tools used in industries, particularly oil exploitation industry, oil fields, oil refineries, petrochemical industry, chemical industry, power industry, shipbuilding industry, metallurgical industry, ore industry, and machinery industry. Striking wrenches are integrally forged from medium carbon steel or alloy steel and are a necessary tool in installation, maintenance and repair of equipment due to their rigid, durable structures.

Large-size fasteners, such as bolts and nuts, are generally used in working environments in the above fields and, thus, require correspondingly-sized heavy duty striking wrenches to meet the work requirements.

However, the heavy duty striking wrenches are too heavy to be conveyed or used by a single worker. A heavy duty striking wrench needs manual support by two workers during conveyance or alignment with a fastener. Since the geometric structure of the heavy duty striking wrench is fixed, it is difficult for the two workers to find out the optimal application point of force for efficient operation. Thus, the operation of the heavy duty striking wrench during conveyance or alignment with a fastener is laborsome to the workers.

Thus, a need exists for a novel easy-to-convey heavy duty striking wrench to overcome the disadvantages of the conventional heavy duty striking wrenches.

### BRIEF SUMMARY OF THE INVENTION

An objective of the present invention is to provide an easy-to-convey heavy duty striking wrench to solve the problems during conveyance or alignment with a fastener resulting from the heavy weights of the conventional heavy duty striking wrenches.

An easy-to-convey heavy duty striking wrench according to the present invention includes a main body having a weight more than 20 kg and including a head and a body integrally connected to the head. The head is adapted to engage with a fastener rotatable about a rotating axis. The head is operable to rotate about a working axis coincident with the rotating axis when the head engages with the fastener. The body has an end opposite to the head. The end of the body is adapted to be hammered by a tool to rotate the main body about the working axis to thereby tighten or loosen the fastener. A first axis passes through the center of gravity of the main body and is parallel to the working axis of the head. The main body further includes a first conveying device configured to be applied with a force through manual or mechanical operation to overcome the weight of the main body, permitting the main body to be conveyed to a working position where the fastener locates. The main body is rotatable about the first axis.

When the head is not engaged with the fastener, the first conveying device is operable to rotate the body about the first axis until the head is in an angular position relative to the fastener permitting engagement of the head with the fastener.

When the head engages with the fastener, the working axis is coincident with the rotating axis of the fastener, permitting the body to rotate about the rotating axis of the fastener to tighten or loosen the fastener.

The force can be applied to the first conveying device along a conveying axis extending in a vertical direction to overcome the weight of the body, moving the body to the working position.

The main body can include a first connection hole defined in the body and extending along the first axis. The first conveying device is mounted to the first connection hole.

The body can include a connecting section and a hammering section adapted to be hammered by the tool. The connecting section includes a first end connected to the head and a second end connected to the hammering section. The connecting section includes first and second surfaces parallel to each other and extending perpendicularly to the first axis. The first connection hole extends from the first surface through the second surface of the connecting section.

The first conveying device can include a first conveying member mounted to an end of the first connection hole. The first conveying member is configured to be applied with the force through the manual or mechanical operation for conveying the main body to the working position.

The first conveying member can be an eye bolt having a loop and a coupling portion engaged with the first connection hole. The first conveying device further includes a rod extending through the loop of the eye bolt. The conveying axis is coincident with the first axis. The force is manually applied to the first conveying member through rod to convey the main body to the working position. The first axis, the working axis, and the rotating axis are parallel to each other when the head is not engaged with the fastener. The working axis is coincident with the rotating axis of the fastener when the head engages with the fastener.

In a case that the weight of the main body is not less than 40 kg, the first conveying device can further include a crane hook device releasably engaged with the first conveying member. The conveying axis is coincident with the first axis. The force is applied to the first conveying member through the crane hook device to convey the main body to the working position.

In an example, the first conveying device further includes another first conveying member engaged with the other end of the first connection hole. The first conveying device further includes a crane hook device releasably engaged with the first conveying members. The conveying axis is perpendicular to the first axis. The force is applied to the first conveying members through the crane hook device to convey the main body to the working position.

In another example, the first conveying device includes a first conveying member coupled with the first connection hole. The first conveying member includes two handle portions on opposite sides of the body. The force is manually applied by the two handle portions to convey the main body to the working position. The first conveying member can further include two loops respectively connected to the two handle portions.

In a case that the weight of the main body is not less than 60 kg, the body can further include a second connection hole extending along a second axis extending perpendicularly to the first axis and intersecting with the first axis at the center of gravity of the main body. The main body further includes a second conveying device mounted to the second connection hole. The second conveying device is configured to be applied with a force through mechanical operation to overcome the weight of the main body with or without using the first conveying device, moving the main body to the working position. The second connection hole can be a screw hole. The second conveying device can include an eye bolt having a loop and a threaded portion engaged with the screw hole.

The present invention will become clearer in light of the following detailed description of illustrative embodiments of this invention described in connection with the drawings.

### DESCRIPTION OF THE DRAWINGS

FIG. 1 is a perspective view of an easy-to-convey heavy duty striking wrench of a first embodiment according to the present invention.

FIG. 2 is an exploded, perspective view of the striking wrench of FIG. 1.

FIG. 3 is a cross sectional view of the striking wrench of FIG. 1.

FIG. 4 is a schematic view illustrating a first example of conveying the striking wrench of FIG. 1.

FIG. 5 is a side view illustrating a second example of conveying the striking wrench of FIG. 1.

FIG. 6 is a perspective view illustrating the second example of conveying the striking wrench of FIG. 1.

FIG. 7 is a perspective view similar to FIG. 6, illustrating manual adjustment of an angular position of the striking wrench.

FIG. 8 is a perspective view illustrating a third example of conveying the striking wrench of FIG. 1.

FIG. 9 is a perspective view illustrating an example of conveying the striking wrench of a second embodiment according to the present invention.

FIG. 10 is a perspective view similar to FIG. 9, illustrating manual adjustment of an angular position of the striking wrench.

FIG. 11 is a perspective view illustrating a fourth example of conveying the striking wrench of FIG. 1.

### DETAILED DESCRIPTION OF THE INVENTION

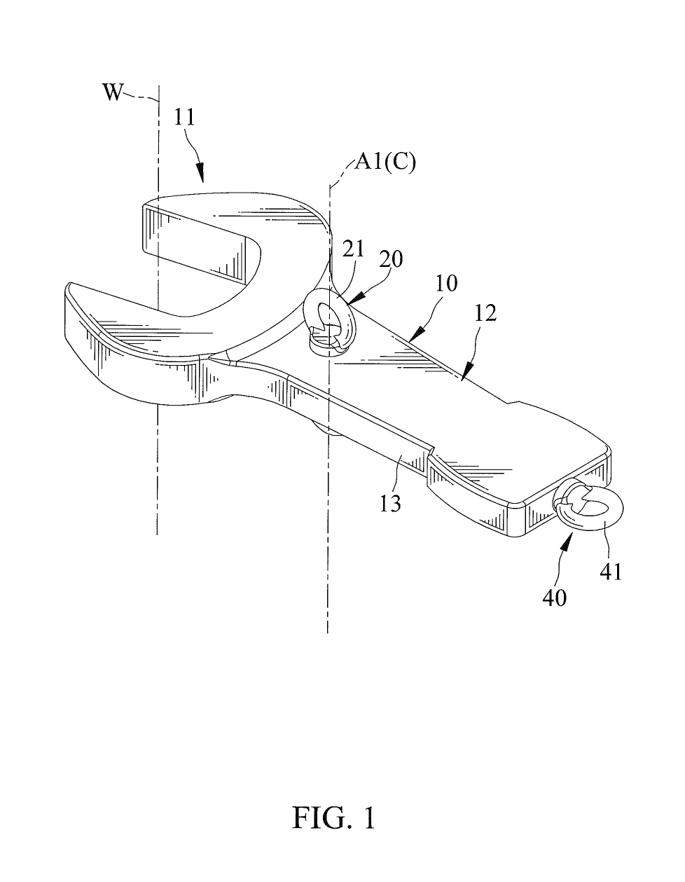

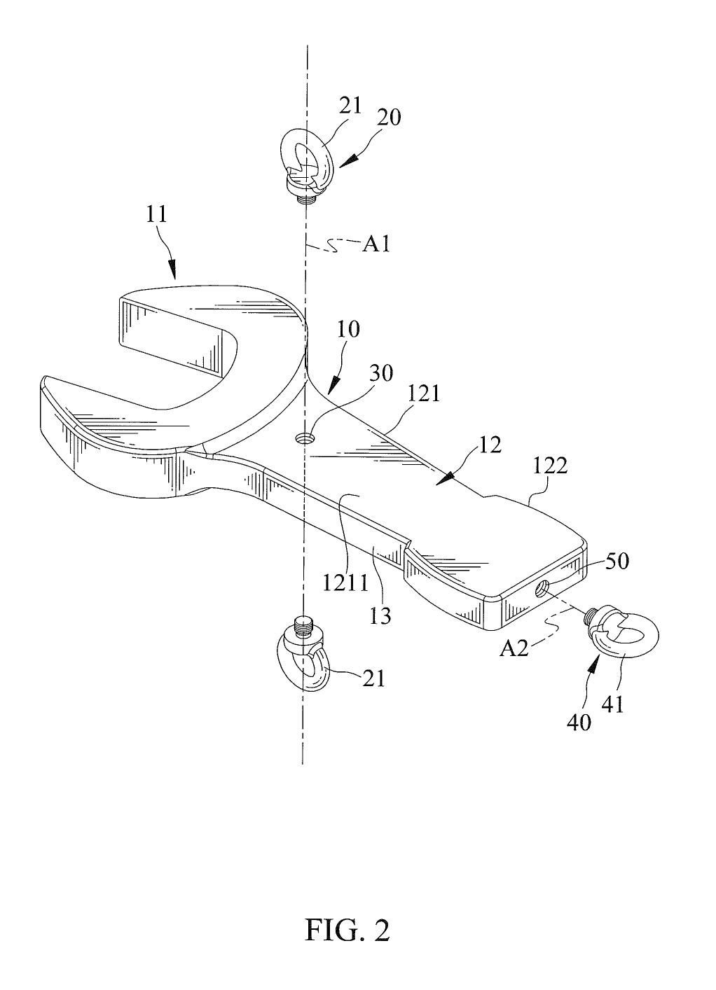

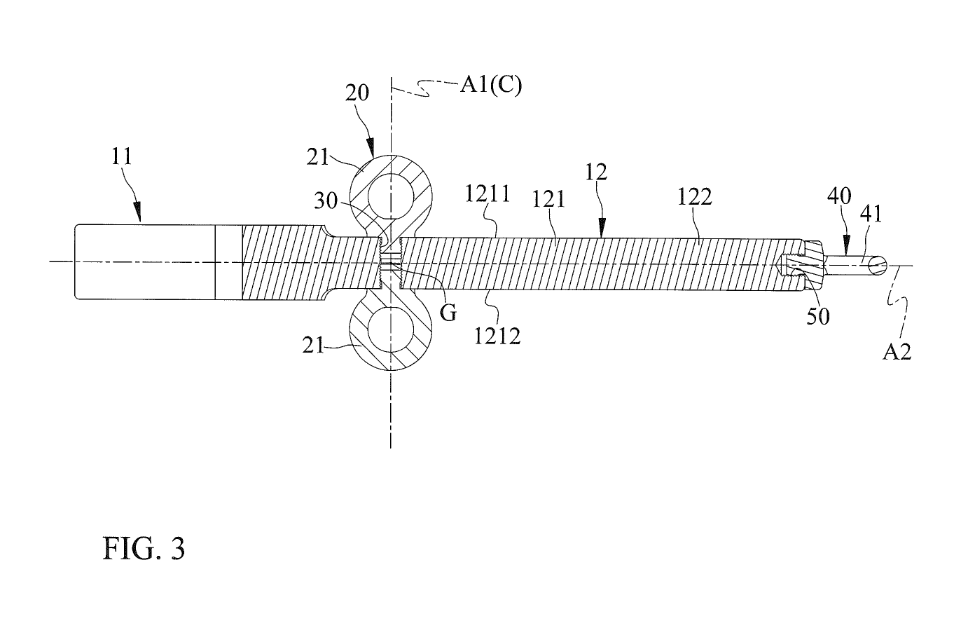

With reference to FIGS. 1-3, an easy-to-convey heavy duty striking wrench of a first embodiment according to the present invention includes a main body 10 having a weight more than 20 kg. The weight of main body 10 can be not less than 40 kg or even 60 kg, which cannot easily be manually conveyed by a single worker or even two workers. The technical features of the present invention is particularly useful in conveyance of heavier striking wrenches.

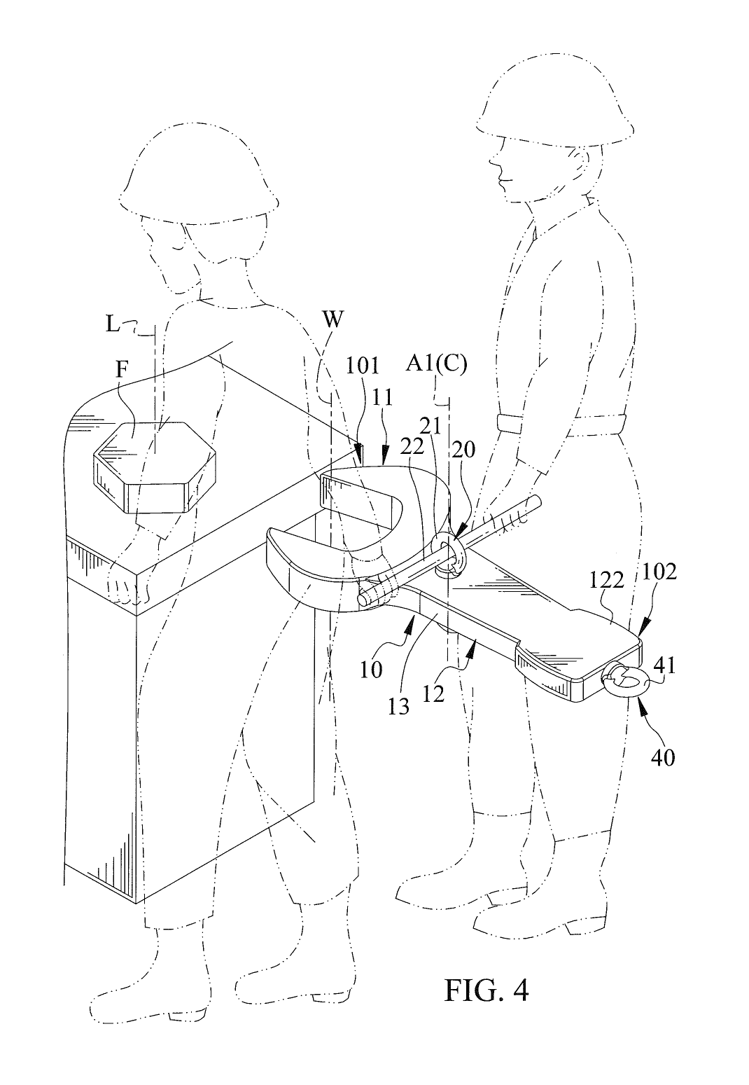

Main body 10 includes a head 11 and a body 12 integrally connected to head 11. Head 11 is adapted to engage with a fastener F, such as a bolt or a nut (FIG. 4), rotatable about a rotating axis L. Head 11 can be operated to rotate about a working axis W coincident with rotating axis L when head 11 engages with fastener F. An end of body 12 opposite to head 11 is adapted to be hammered by a tool to rotate main body 10 about working axis W to thereby tighten or loosen fastener F. In this embodiment, head 11 includes two jaws defining an opening for engaging with two opposite sides of fastener F. A first axis A1 passes through the center of gravity G of main body 10 and is parallel to working axis W of head 11.

Main body 10 further includes a first conveying device 20 configured to be applied with a force through manual or mechanical operation to overcome the weight of main body 10, permitting main body 11 to be conveyed to a working position where fastener F locates. When head 11 is not engaged with fastener F, first conveying device 20 is operable to rotate body 10 about first axis A1 until head 11 is in an angular position relative to fastener F permitting engagement of head 11 with fastener F. When head 11 engages with fastener F, working axis W is coincident with rotating axis L of fastener F, permitting body 10 to rotate about rotating axis L of fastener F to tighten or loosen fastener F.

The force is applied to first conveying device 20 along a conveying axis C to overcome the weight of body 10, moving body 10 to the working position. Conveying axis C extends in a vertical direction. After body 10 is lifted, body 10 can be moved to the working position.

Main body 10 includes a first connection hole 30 defined in body 12 and extending along first axis A1. First conveying device 20 is mounted to first connection hole 30. In this embodiment, body 12 includes a connecting section 121 and a hammering section 122 adapted to be hammered by the tool. Connecting section 121 includes a first end connected to head 11 and a second end connected to hammering section 122. Connecting section 121 includes first and second surfaces 1211 and 1212 parallel to each other and extending perpendicularly to first axis A1. First connection hole 30 is a screw hole extending from first surface 1211 through second surface 1212 of connecting section 121. Main body 10 further includes two lateral surfaces 13 extending from head 11 to body 12. First axis A1 is located between and spaced from lateral surfaces 13.

In this embodiment, first conveying device 20 includes two first conveying members 21 mounted to first connection hole 30. First conveying members 21 are configured to be applied with a force through the manual or mechanical operation for conveying main body 10 to the working position.

In this embodiment, each first conveying member 21 is an eye bolt having a loop and a coupling portion in the form of a threaded portion engaged with an end of first connection hole 30.

In this embodiment, body 12 further includes a second connection hole 50 extending along a second axis A2. Second axis A2 extends perpendicularly to first axis A1 and intersects with first axis A1 at the center of gravity G of main body 10. Main body 10 further includes a second conveying device 40 mounted to second connection hole 50. Second conveying device 40 is configured to be applied with a force through mechanical operation to overcome the weight of main body 10 with or without using first conveying device 20, moving main body 11 to the working position. Second conveying device 40 includes a second conveying member 41 in the form of an eye bolt having a loop and a coupling portion. In this embodiment, the coupling portion of second conveying member 41 is a threaded portion in threading connection with the connection hole 50 in the form of a screw.

In a first example shown in FIG. 4, first conveying device 20 further includes a rod 22 extending through the loop of one of first conveying members 21. Conveying axis C is coincident with first axis A1. A force is manually applied by two workers to first conveying member 21 through rod 22 to convey main body 10 to the working position. During the conveyance, first axis A1 is preferably maintained to be parallel to rotating axis L of fastener F. Since conveying axis C is coincident with first axis A1, working axis W and rotating axis L are parallel to each other when head 11 is not engaged with fastener F. Working axis W is coincident with rotating axis L of fastener F when head 11 engages with fastener F. Since first conveying member 21 extends along first axis A1 that extends through the center of gravity G of main body 10, main body 10 can be stably conveyed. Namely, first axis A1 separates main body 10 into a front section 101 including head 11 and a rear section 102 including body 12 to keep balance. The difficulty in finding the optimal force application point for conveying conventional heavy duty striking wrenches by workers through manual operation is, thus, overcome.

Furthermore, one of the two workers can slightly push one of lateral surfaces 13 of striking section 122 to rotate main body 10 about first axis A 1 until head 11 is moved to an angular position aligned with fastener F. In this embodiment, two parallel sides of the two jaws of head 11 are aligned with two parallel sides of fastener F. Thus, head 11 can easily engage with fastener F. After head 11 has engaged with fastener F, working axis W is coincident with rotating axis L of fastener F when head 11 engages with fastener F. As a result, main body 10 can rotate about rotating axis L to tighten or loosen fastener F. The difficulty in aligning a conventional heavy duty striking wrench with a fastener due to the heavy weight of the conventional heavy duty striking wrench is, thus, overcome.

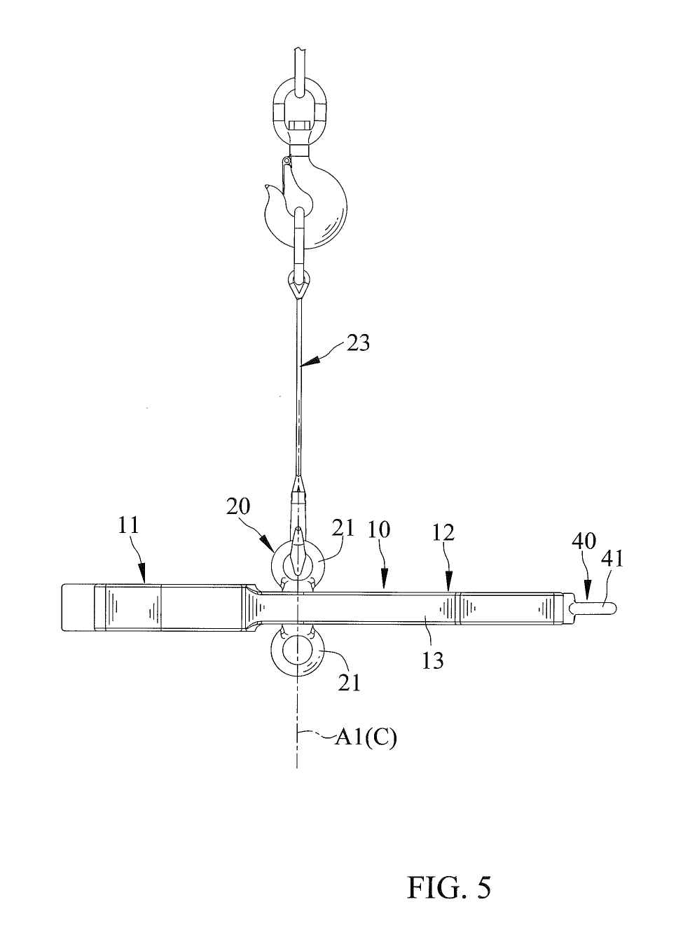

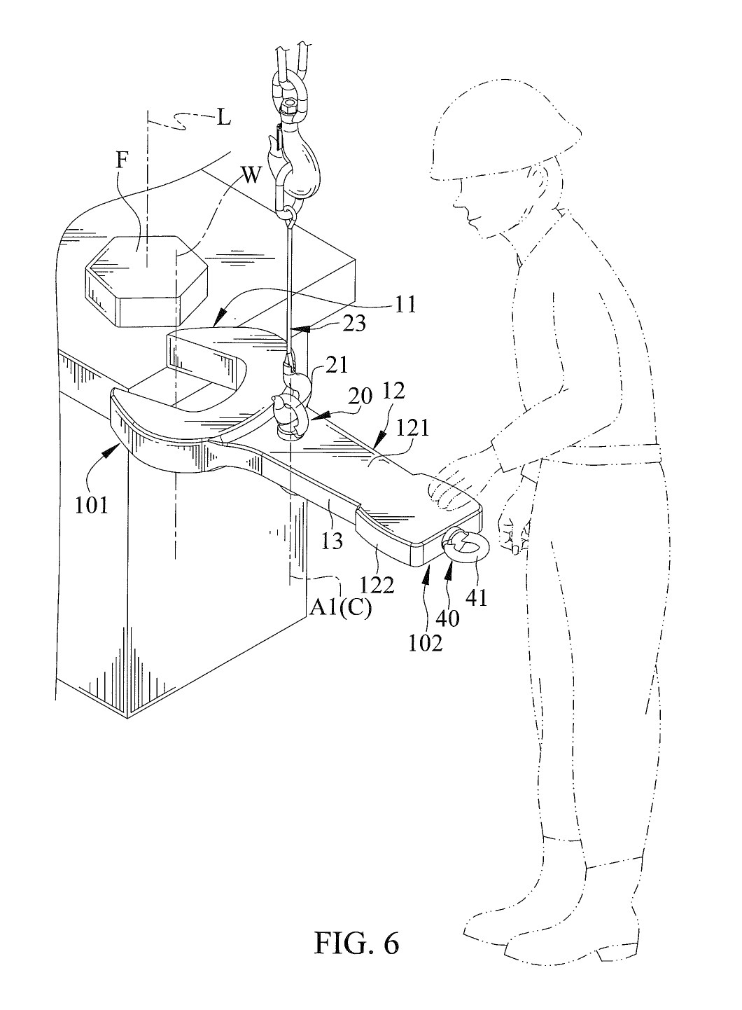

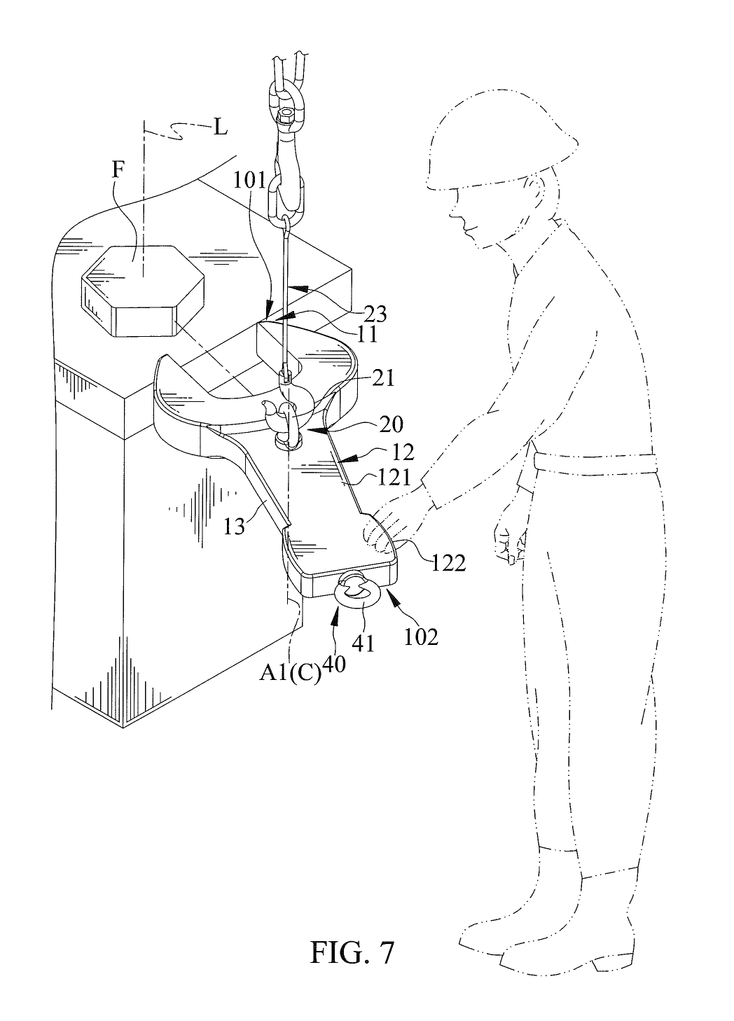

FIGS. 5-7 show a second example of conveying the heavy duty striking wrench according to the present invention. In this example, first conveying device 20 further includes a crane hook device 23 having a crane hook releasably engaged with one of first conveying members 21. Conveying axis C is coincident with first axis A1. A force is applied to first conveying member 21 through crane hook device 23 to convey main body 10 to the working position. During the conveyance, first axis A1 is parallel to rotating axis L of fastener F. Conveying axis C coincident with first axis A1 extends in the vertical direction. Working axis W and rotating axis L are parallel to each other when head 11 is not engaged with fastener F. Working axis W is coincident with rotating axis L of fastener F when head 11 engages with fastener F. Since first conveying member 21 and crane hook device 23 extend along first axis A1 that extends through the center of gravity G of main body 10, main body 10 can be stably conveyed. Namely, first axis Al separates main body 10 into front section 101 and rear section 102 to keep balance. The laborsome manual operation by workers for conveying a conventional heavy duty striking wrench is, thus, overcome.

Furthermore, a worker can slightly push one of lateral surfaces 13 of striking section 122 to rotate main body 10 about first axis A1 until head 11 is moved to an angular position aligned with fastener F to permit easy engagement with fastener F. After head 11 has engaged with fastener F, working axis W is coincident with rotating axis L of fastener F when head 11 engages with fastener F. As a result, main body 10 can rotate about rotating axis L to tighten or loosen fastener F. The difficulty in aligning a conventional heavy duty striking wrench with a fastener due to the heavy weight of the conventional heavy duty striking wrench is, thus, overcome.

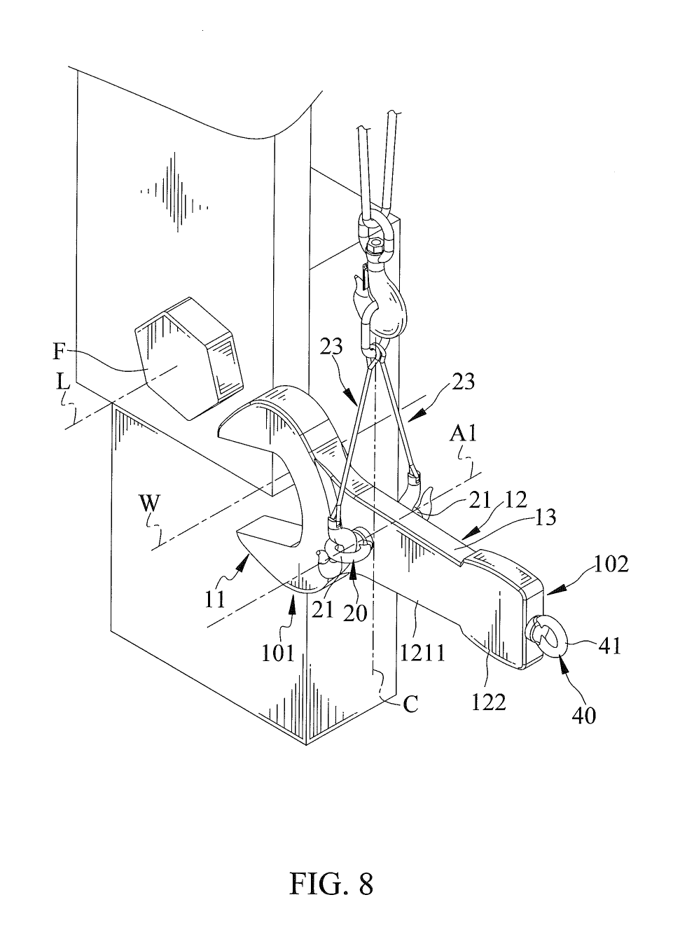

FIG. 8 shows a third example of conveying the heavy duty striking wrench according to the present invention. In this embodiment, first conveying device 20 further includes a crane hook device 23 having two crane hooks releasably engaged with first conveying members 21. Conveying axis C is perpendicular to first axis A1. A force is applied to first conveying members 21 through crane hook device 23 to convey main body 10 to the working position. During the conveyance, first axis A1 is parallel to rotating axis L of fastener F. Conveying axis C is perpendicular to first axis A1. First axis A1, working axis W and rotating axis L are parallel to each other when head 11 is not engaged with fastener F. Working axis W is coincident with rotating axis L of fastener F when head 11 engages with fastener F. Since first axis A1 extends through the center of gravity G of main body 10, main body 10 can be stably conveyed. Namely, first axis Al separates main body 10 into front section 101 and rear section 102 to keep balance. The laborsome manual operation by workers for conveying a conventional heavy duty striking wrench is, thus, overcome.

Furthermore, a worker can slightly push one of lateral surfaces 13 of striking section 122 to rotate main body 10 about first axis A1 until head 11 is moved to an angular position aligned with fastener F to permit easy engagement with fastener F. Thus, head 11 can easily engage with fastener F. After head 11 has engaged with fastener F, working axis W is coincident with rotating axis L of fastener F when head 11 engages with fastener F. As a result, main body 10 can rotate about rotating axis L to tighten or loosen fastener F. The difficulty in aligning a conventional heavy duty striking wrench with a fastener due to the heavy weight of the conventional heavy duty striking wrench is, thus, overcome.

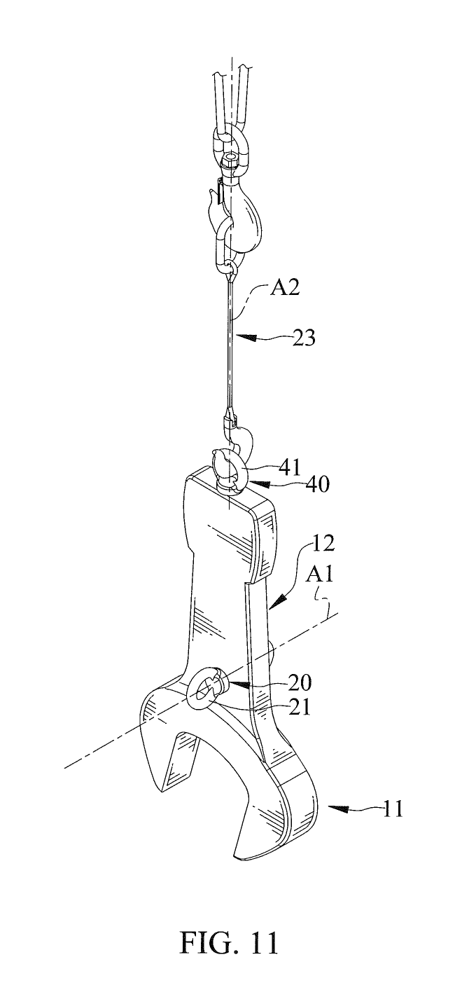

FIG. 11 shows a fourth example of conveying the heavy duty striking wrench according to the present invention. In this embodiment, first conveying device 20 further includes a crane hook device 23 having a crane hook releasably engaged with second conveying member 41. Crane hook device 23 extends along second axis A2 that intersects with first axis A1 at the center of gravity G of main body 10. Thus, main body 10 can be stably conveyed. The difficulty in finding the optimal force application point for conveying conventional heavy duty striking wrenches by workers through manual operation is, thus, overcome.

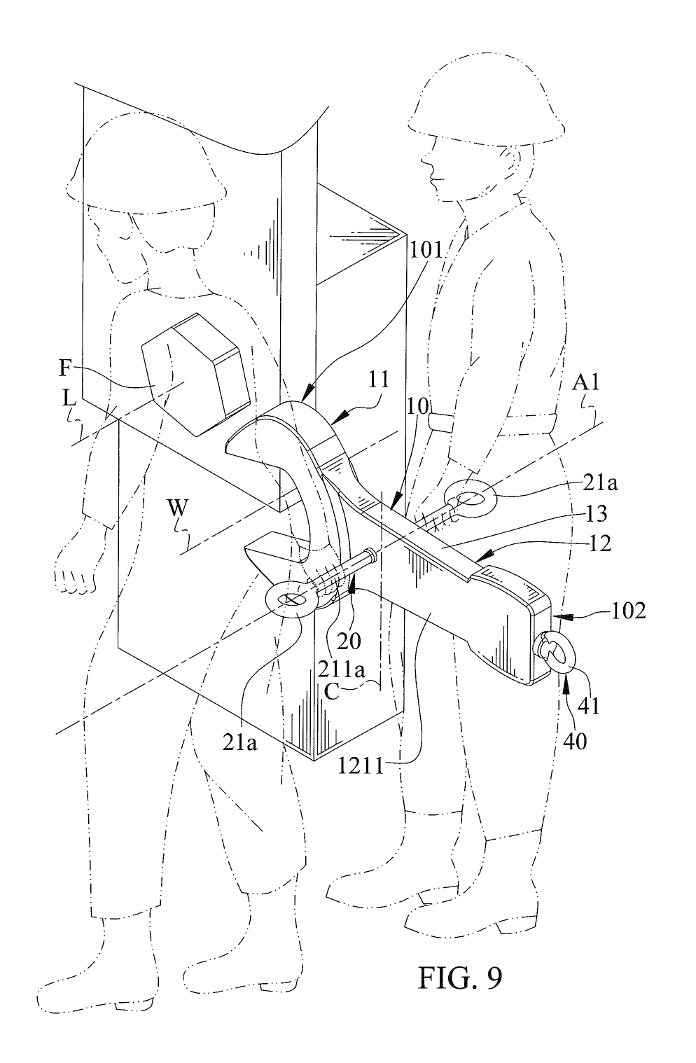

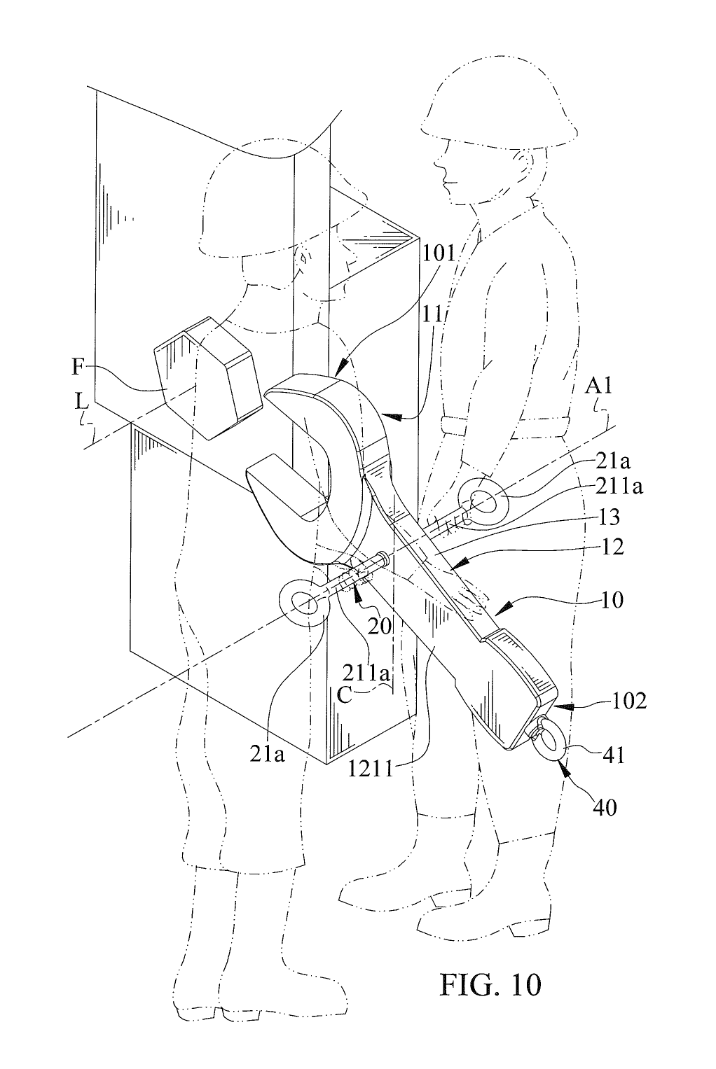

FIGS. 9 and 10 show a heavy duty striking wrench of a second embodiment according to the present invention. In this embodiment, first conveying device 20 includes a first conveying member 21a coupled with first connection hole 30. First conveying member 21a includes two handle portions 211a on opposite sides of body 12. First conveying member 21a further includes two loops 21a respectively connected to handle portions 211a. The force is manually applied by handle portions 211a to convey main body 10 to the working position. During the conveyance, first axis A1 is parallel to rotating axis L of fastener F. Since conveying axis C is coincident with first axis A1, working axis W and rotating axis L are parallel to each other when head 11 is not engaged with fastener F. Working axis W is coincident with rotating axis L of fastener F when head 11 engages with fastener F. Since first conveying member 21 extends along first axis A1 that extends through the center of gravity G of main body 10, main body 10 can be stably conveyed. Namely, first axis A1 separates main body 10 into front section 101 and rear section 102 to keep balance. The laborsome manual operation by workers for conveying a conventional heavy duty striking wrench is, thus, overcome.

Furthermore, one of the two workers can slightly push one of lateral surfaces 13 of striking section 122 to rotate main body 10 about first axis A1 until head 11 is moved to an angular position aligned with fastener F. In this embodiment, two parallel sides of the two jaws of head 11 are aligned with two parallel sides of fastener F. Thus, head 11 can easily engage with fastener F. After head 11 has engaged with fastener F, working axis W is coincident with rotating axis L of fastener F when head 11 engages with fastener F. As a result, main body 10 can rotate about rotating axis L to tighten or loosen fastener F. The difficulty in aligning a conventional heavy duty striking wrench with a fastener due to the heavy weight of the conventional heavy duty striking wrench is, thus, overcome.

It can be appreciated that first conveying device 20 and second conveying device 40 can be used independently or jointly. Furthermore, the sizes of first and second conveying members 21 and 41 can be varied according to needs. Furthermore, first conveying device 20 can include only one first conveying member 21. Furthermore, first conveying members 21 can be of other forms detachably engaged with or fixed to first connecting hole 30. Likewise, second conveying member 41 can be of any other form detachably engaged with or fixed to second connecting hole 50.

Although specific embodiments have been illustrated and described, numerous modifications and variations are still possible without departing from the scope of the invention. The scope of the invention is limited by the accompanying claims.

1. An easy-to-convey heavy duty striking wrench comprising a main body having a weight more than 20 kg and including a head and a body integrally connected to the head, with the head adapted to engage with a fastener rotatable about a rotating axis, with the head operable to rotate about a working axis coincident with the rotating axis when the head engages with the fastener, with the body having an end opposite to the head, with the end of the body adapted to be hammered by a tool to rotate the main body about the working axis to thereby tighten or loosen the fastener, with a first axis passing through a center of gravity of the main body and parallel to the working axis of the head, with the main body further including a first conveying device configured to be applied with a force through manual or mechanical operation to overcome the weight of the main body, permitting the main body to be conveyed to a working position where the fastener locates, and with the main body rotatable about the first axis,
wherein when the head is not engaged with the fastener, the first conveying device is operable to rotate the body about the first axis until the head is in an angular position relative to the fastener permitting engagement of the head with the fastener, and
wherein when the head engages with the fastener, the working axis is coincident with the rotating axis of the fastener, permitting the body to rotate about the rotating axis of the fastener to tighten or loosen the fastener.

2. The easy-to-convey heavy duty striking wrench as claimed in claim 1, wherein the force is applied to the first conveying device along a conveying axis to overcome the weight of the body, moving the body to the working position, and wherein the conveying axis extends in a vertical direction.

3. The easy-to-convey heavy duty striking wrench as claimed in claim 2, with the main body including a first connection hole defined in the body and extending along the first axis, and with the first conveying device mounted to the first connection hole.

4. The easy-to-convey heavy duty striking wrench as claimed in claim 3, with the body including a connecting section and a hammering section adapted to be hammered by the tool, with the connecting section including a first end connected to the head and a second end connected to the hammering section, with the connecting section including first and second surfaces parallel to each other and extending perpendicularly to the first axis, and with the first connection hole extending from the first surface through the second surface of the connecting section.

5. The easy-to-convey heavy duty striking wrench as claimed in claim 4, with the first conveying device including a first conveying member mounted to an end of the first connection hole, and with the first conveying member configured to be applied with the force through the manual or mechanical operation for conveying the main body to the working position.

6. The easy-to-convey heavy duty striking wrench as claimed in claim 5, with the first conveying member being an eye bolt having a loop and a coupling portion engaged with the first connection hole, with the first conveying device further including a rod extending through the loop of the eye bolt, with the conveying axis coincident with the first axis, with the force manually applied to the first conveying member through the rod to convey the main body to the working position, wherein the first axis, the working axis, and the rotating axis are parallel to each other when the head is not engaged with the fastener, and wherein the working axis is coincident with the rotating axis of the fastener when the head engages with the fastener.

7. The easy-to-convey heavy duty striking wrench as claimed in claim 5, with the weight of the main body being not less than 40 kg, with the first conveying device further including a crane hook device releasably engaged with the first conveying member, with the conveying axis being coincident with the first axis, with the force applied to the first conveying member through the crane hook device to convey the main body to the working position, wherein the first axis, the working axis, and the rotating axis are parallel to each other when the head is not engaged with the fastener, and wherein the working axis is coincident with the rotating axis of the fastener when the head engages with the fastener.

8. The easy-to-convey heavy duty striking wrench as claimed in claim 5, with the weight of the main body being not less than 40 kg, with the first conveying device further including another first conveying member engaged with another end of the first connection hole, with the first conveying device further including a crane hook device releasably engaged with the first conveying members, with the conveying axis being perpendicular to the first axis, with the force applied to the first conveying members through the crane hook device to convey the main body to the working position, wherein the first axis, the working axis, and the rotating axis are parallel to each other when the head is not engaged with the fastener, and wherein the working axis is coincident with the rotating axis of the fastener when the head engages with the fastener.

9. The easy-to-convey heavy duty striking wrench as claimed in claim 4, with the first conveying device including a first conveying member coupled with the first connection hole, with the first conveying member including two handle portions on opposite sides of the body, with the force manually applied by the two handle portions to convey the main body to the working position, wherein the first axis, the working axis, and the rotating axis are parallel to each other when the head is not engaged with the fastener, and wherein the working axis is coincident with the rotating axis of the fastener when the head engages with the fastener.

10. The easy-to-convey heavy duty striking wrench as claimed in claim 9, with the first conveying member further including two loops respectively connected to the two handle portions.

11. The easy-to-convey heavy duty striking wrench as claimed in claim 6, with the weight of the main body being not less than 60 kg, with the body further including a second connection hole extending along a second axis extending perpendicularly to the first axis and intersecting with the first axis at the center of gravity of the main body, with the main body further including a second conveying device mounted to the second connection hole, and with the second conveying device configured to be applied with a force through mechanical operation to overcome the weight of the main body with or without using the first conveying device, moving the main body to the working position.

12. The easy-to-convey heavy duty striking wrench as claimed in claim 11, with the second connection hole being a screw hole, and with the second conveying device including an eye bolt having a loop and a threaded portion engaged with the screw hole.

13. The easy-to-convey heavy duty striking wrench as claimed in claim 2, with the body including a connecting section and a hammering section adapted to be hammered by the tool, with the connecting section including a first end connected to the head and a second end connected to the hammering section, with the connecting section including first and second surfaces parallel to each other and extending perpendicularly to the first axis, with a first screw hole extending from the first surface through the second surface of the connecting section, with the first conveying device including two first conveying members respectively mounted to two ends of the first screw hole, with each of the two first conveying members including a threaded portion in threading connection with one of the two ends of the first screw hole, with the first conveying device further including a crane hook device releasably engaged with at least one of the two first conveying members, and with the force applied through the crane hook device to at least one of the first conveying members to convey the main body to the working position.

14. The easy-to-convey heavy duty striking wrench as claimed in claim 13, with the body further including a second screw hole extending along a second axis extending perpendicularly to the first axis and intersecting with the first axis at the center of gravity of the main body, with the main body further including a second conveying member having a threaded portion in threading connection with the second screw hole, and with the second conveying member configured to be applied with a force through mechanical operation to overcome the weight of the main body with or without using the first conveying device, moving the main body to the working position.
